(19) United States
(12) Patent Application Publication
(10) Pub. No.: US 2003/0157720 A1
(43) Pub. Date: Aug. 21, 2003

(54) Protein standard for estimating size and mass

(75) Inventor: Chuan Li, San Diego, CA (US)

Correspondence Address: Chuan Li, Apt. 158, 7908 Avenida Navidad, San Diego, CA, 92122, US

(73) Assignee: Expression Technologies Inc.

(21) Appl. No.: 10/068,663

(22) Filed: Feb. 6, 2002

(51) Int. Cl. G01N 21/93

(52) U.S. Cl. 436/15; 436/177; 436/86; 422/61

(57) ABSTRACT

The invention relates to a protein standard comprising a collection of at least three polypeptides of different size and mass. The polypeptides can be from natural or recombinant sources or both. The protein standard can be used for simultaneously estimating both the size and mass of another protein or other proteins.

### CROSS-REFERENCE TO RELATED APPLICATIONS

Not applicable

### STATEMENT REGARDING FEDERALLY SPONSORED RESEARCH AND DEVELOPMENT

Not applicable

### REFERENCE TO SEQUENCE LISTING

A sequence listing of this invention is submitted on paper after the Declaration. The sequence listing was generated by software Patent-In 3.1.

### BACKGROUND OF THE INVENTION

Protein is one of the essential components of all living organisms. It is chemical condensation polymer of amino acids. A single linear array of amino acids is called a polypeptide. Most proteins contain only one polypeptide. Some proteins contain more than one polypeptides and non-polypeptide groups. A fragment of a protein is not an intact protein, but it is a polypeptide. In practice, protein and polypeptide are interchangeable terms. Gel electrophoresis of proteins is a commonly used technique in molecular biology. Proteins are separated on the basis of their size (molecular weight), their intrinsic charges, and their shape (conformation). Under a denaturing condition, electrophoretic mobility of a protein is inversely related to its size (see Current Protocols in Protein Science, Eds. Coligan et al., Current Protocols, U.S.A., Vol. 2 pp. 10.0.1-10.1.29 (1995)). The size of a protein is measured by kilo Dalton (kD).

Polyacrylamide gel electrophoresis (PAGE) is routinely used for the separation of proteins. Many commercially available mixtures of proteins are used as protein standards during PAGE. Some of these proteins are from natural sources. For example, the protein molecular weight standard, high range, Life Technologies, 2000-2001 catalogue, Cat. No. 16001-018 is a mixture of seven proteins from natural sources: myosin (H-chain, 200 kD), phosphorylase b (97 kD), bovine serum albumin (68 kD), ovalbumin (43 kD), carbonic anhydrase (29 kD), B-lactoglobulin (18 kD) and lysozyme (14 kD). Other proteins are from recombinant sources. For example, the 10 kD protein ladder, Life Technologies, 2000-2001 catalogue, Cat. No. 10064-012 is composed of twelve proteins (protein fragments) from recombinant source (Hartley, U.S. Pat. No. 5,449,758). These and all other protein standards are used for estimating only the sizes of proteins. None can also be used for estimating the masses of proteins (amounts of proteins).

A few assays are used to estimate the masses of proteins (see Current Protocols in Protein Science, Eds. Coligan et al., Current Protocols, U.S.A., Vol. 1, pp. 3.4.1-3.4.15 (1995)). These include ultraviolet (UV) absorption, the Biuret assay, the Lowry assay, the Bicinchinoic Acid (BCA) assay, and the Bratford assay. All the protein assays are designed to estimate the total protein mass. Therefore they cannot measure a single protein mass in a mixture of two or more proteins, nor are they designed to estimate the size of protein. In addition, non-protein substances often present in protein solutions including detergents, lipids, buffers, salts and reducing agents may affect these assays. None of these assays can be used for estimating the sizes of proteins.

In conclusion, both a protein standard and an assay for estimating mass are needed if both the size and mass of a purified protein need to be determined by current techniques.

When the size and mass of each protein of a mixture of two or more proteins need to be determined, the current available methods will be laborious and time consuming. Non-protein substances in the protein sample also make it difficult to estimate the mass of the protein. Therefore a protein standard, which can simultaneously estimate both protein size and mass of a sample protein or a mixture of proteins and eliminate the effects by non-protein substances often present in protein solutions, will save time and cost for biomedical research.

### SUMMARY OF THE INVENTION

In general, the invention provides a protein standard. More specifically, the invention provides a protein standard comprising a collection of polypeptides obtained from commercially available natural sources or from recombinant sources or both wherein

(a) the protein standard contains at least three polypeptides of different size and of different mass;

(b) the sizes of all of the polypeptides in kilo Dalton cover a range of at least separable by a given PAGE; and

(c) the masses of all of the polypeptides cover a range of at least detectable by a detection assay.

Wherein the range of the size covers from a few kD to hundreds of kD. Wherein the range of the mass covers a few nanograms to tens of micrograms. Wherein the detecting intensity of the detection assay is related to the polypeptide mass.

The present invention also provides a protein standard kit comprising a carrier means having in close confinement therein at least one container means where the first container means contains the above-described protein standard.

The present invention further provides a method of using a protein standard to estimate the size and the mass of the polypeptide in a protein sample comprising:

(a) electrophoresing simultaneously in separate lanes of a gel the above-described protein standard and the protein sample;

(b) detecting the polypeptides on the gel with a detection assay;

(c) comparing the sizes of polypeptides of said protein standard with the size of the polypeptide in the protein sample to estimate its size; and

(d) comparing the masses of polypeptides of said protein standard with the mass of the polypeptide in the protein sample to estimate its mass.

Wherein the detection intensity of the detection assay relates to the polypeptide mass.

Wherein the protein sample may contain one or more polypeptides.

The present invention also provides a method of preparing a protein standard:

(a) obtaining a few polypeptides with known sizes;

(b) estimating the mass of each of the polypeptides; and

(c) combining the polypeptides with different size and mass.

Wherein the protein standard is produced wherein the standard contains at least three polypeptides. Wherein the polypeptides are from natural sources, recombinant sources, or both. Wherein the range of their sizes is separable by a given PAGE and the range of their masses is detectable by a given detection assay. Wherein the mass of each of the polypeptides is estimated by a protein assay. Wherein the detection intensity of the protein assay is related to the polypeptide mass. Wherein the mass of each of the polypeptides is estimated by polyacrylamide gel electrophoresis followed by a detection assay. Wherein the detection intensity of the detection assay is related to the polypeptide mass.

Further objects and advantages of the invention will become apparent from a consideration of the drawings and ensuing description.

### BRIEF DESCRIPTION OF THE FIGURES

FIG. 1. A protein standard consisting of chicken egg white proteins. Their masses in micrograms (ug) are indicated at right of the Coomassie Blue-stained SDS polyacrylamide gel. Their sizes in kilo Dalton (kD) are indicated at left of the gel.

FIG. 2. A protein standard consisting of recombinant proteins. Their masses in micrograms (ug) are indicated at right of the Coomassie Blue-stained SDS polyacrylamide gel. Their sizes in kilo Dalton (kD) are indicated at left of the gel.

FIG. 3. A protein standard consisting of natural and recombinant proteins. Their masses in micrograms (ug) are indicated at right of the Coomassie Blue-stained SDS polyacrylamide gel. Their sizes in kilo Dalton (kD) are indicated at left of the gel.

### DETAILED DESCRIPTION OF THE INVENTION

### The Invention Relates to a Protein Standard

In one embodiment, the invention relates to a protein standard comprising:

A collection of polypeptides wherein;

(a) the protein standard contains at least three polypeptides of different size and of different mass. In one preferred embodiment, the polypeptides are from natural sources. In another preferred embodiment, the polypeptides are from recombinant sources. In a further preferred embodiment, the polypeptides are from both natural and recombinant sources;

(b) the size of each of the polypeptides is separable by a given separation assay. In a preferred embodiment, the separation assay is polyacrylamide gel electrophoresis (PAGE). In one preferred embodiment, the range of sizes covers from a few kD to tens of kD. In another preferred embodiment, the range of sizes covers from tens of kD to hundreds of kD. In a further preferred embodiment, the range of sizes covers from a few kD to hundreds of kD. As understood by those skilled in the art, the actual sizes of polypeptides used in the protein standard are not important as long as they can be separated by the given separation assay and they are useful in estimating the size of the polypeptide in the protein sample. Obviously the polypeptides that exceed the range of the separation assay are not useful in the protein standard. However one can use the polypeptides that fit within the range of the separation assay. As understood by the skilled in the art, there are few polypeptides that their sizes are exact integers. However the polypeptides with sizes of approximate integers are convenient to use in the protein standard; and

(c) the mass of each of the polypeptides is detectable by a given detection assay. In a preferred embodiment, the detection assay is Coomassie Blue staining assay. In another preferred embodiment, the detection assay is silver staining assay. In yet another preferred embodiment, the detection assay is SDS precipitation. In a further embodiment, the detection assay is a reversible metal staining assay. In another preferred embodiment, the detection assay is fluorescamine labeling. As understood by those skilled in the art, any detection assay can be used as long as the mass of the polypeptide is related to the detection intensity of the assay. The range of mass covers from a few nanograms to tens of micrograms. As will be recognized by one skilled in the art that the mass in nanogram or microgram as an integer is convenient, mass in nanogram or microgram as a fraction or a decimal may also be used.

In one preferred embodiment, the protein standard comprises of a collection of natural polypeptides. In another preferred embodiment, the protein standard comprises of a collection of recombinant polypeptides. In further preferred embodiment, the protein standard comprises of a collection of both natural and recombinant polypeptides. The protein standard may also comprise of a collection of synthetic polypeptides. As will be understood by those of skill in the art that the proteins or polypeptides used to form the protein standard can be from one or more than one sources. In one preferred embodiment, the source is chicken egg white. In another preferred embodiment, the sources are recombinant polypeptides. In further preferred embodiment, the sources are collection of natural and recombinant polypeptides from different sources.

In another embodiment, the invention relates to a protein standard kit comprising a carrier means having in close confinement therein at least one container means such as a vial, tube or the like, where the first container means contains the above-described protein standard.

In another preferred embodiment, the invention relates to a method of using a protein standard to estimate the size and mass of the polypeptide in a protein sample comprising:

(a) electrophoresing simultaneously on a gel the above-described protein standard and the protein sample;

(b) detecting the polypeptides on the gel with a detection assay;

(c) comparing the relative positions of the polypeptides in the protein standard with the relative position of the polypeptide in the protein sample to estimate the size of the polypeptide in the protein sample; and

(d) comparing the relative detecting intensities of the polypeptides in the protein standard with the relative intensity of the polypeptide in the protein sample to estimate the mass of the polypeptide in the protein sample.

Wherein the protein sample may contain a purified polypeptide or a mixture of polypeptides. In the case of a mixture of polypeptides, each polypeptide will be separated by polyacrylamide gel. The size and mass of each of these polypeptides can be estimated simultaneously. In addition, non-protein substances often present in protein solution including detergents, lipids, buffers, salts, and reducing agents should not affect the detection, since these non-protein substances are separated from the sample polypeptide during electrophoresis and are washed out during staining and de-staining procedures.

The commonly used analytical method (though not the only one) for fractionating polypeptide molecules on the basis of size is polyacrylamide gel electrophoresis. The principle of this method is that polypeptide molecules migrate through the gel as though it were a sieve that retards the movement of the largest molecules to the greatest extend and the movement of the smallest molecules to the least extent. The polypeptides fractionated by polyacrylamide gel electrophoresis can be visualized directly by above-mentioned detection assays. Preferably, the polypeptide-containing polyacrylamide gel is stained with an assay that its detection intensity relates to the polypeptide mass.

In another embodiment, the invention relates to a method of preparing a protein standard comprising:

(a) obtaining a few polypeptides with known sizes;

(b) estimating the mass of each of the polypeptides; and

(c) combining the polypeptides with different sizes and different masses to make a protein standard.

Wherein the protein standard is produced such that the standard contains at least three polypeptides. Wherein the range of their sizes is separable by a given PAGE and the range of their masses is distinguishable by a given detection assay. Wherein the polypeptides may be obtained from natural sources or recombinant sources or both.

Wherein the mass of each of the polypeptide may be estimated by a protein assay. Wherein the protein assay is same or similar as that used in the detection assay after PAGE. In one preferred embodiment, the estimation of the mass of each of the polypeptides is accomplished without a standard protein. In another preferred embodiment, the estimation of each of the polypeptides is accomplished with a standard protein with known size and mass. In one preferred embodiment, the standard protein with known size and mass is bovine serum albumin. In another preferred embodiment, the standard protein with known size and mass is insulin. In a further preferred embodiment, the standard protein with known molecular weight and mass is lysozyme. One skilled in the art will recognize that the estimation of mass is most accurate when the detection property of the standard protein with a particular protein assay is similar as the detection property of the polypeptide in the protein sample. If proteins have similar detection property with a protein assay, it means that similar amount of these proteins will give similar detection intensity with the particular protein assay.

Wherein the mass of each of the polypeptide may be estimated by PAGE followed by a detection assay. In this case, the staining intensity of each of the polypeptide is compared with the staining intensities of different masses of a standard protein on the same gel. A machine such as a densitometry scanner may aid the comparison. The mass of each of the polypeptide may be calculated from the comparison. The calculation may be aided by plotting a graph or by other plotting means such as computer software.

In one preferred embodiment, all the polypeptides in the protein standard are obtained from natural source such as chicken egg white. In another preferred embodiment, all the polypeptides are from commercial natural proteins such as bovine serum albumin, lysozyme, and insulin. In yet another preferred embodiment, all the polypeptides are obtained from recombinant sources including such proteins as bacterial phage T7 RNA polymerase, Glutathione S-transferase, human retinoid X receptor beta ligand binding domain, and bacterial thioredoxin. In further preferred embodiment, some polypeptides are from natural sources, others are from recombinant sources. In yet further preferred embodiment, the polypeptides are obtained from an automatic peptide synthesizer.

The invention is useful as a protein standard to be used during electrophoresis. It is convenient and easy to use since one skilled in the art can quickly calculate the size of an unknown polypeptide according the known sizes of the polypeptides in the protein standard. The calculation may be aided by plotting a graph or by other plotting means such as a computer software.

In addition, the protein standard of the invention not only allows one to estimate the size of a polypeptide but also to determine the mass of the polypeptide. The molecular mass of a polypeptide can be estimated following polyacrylamide gel electrophoresis and Coomassie blue staining by comparing the staining intensity of the polypeptide of unknown molecular mass with the intensities of the polypeptides of known molecular masses in the protein standard. A machine such as a densitometry scanner may aid the estimation.

In a further preferred embodiment, the recombinant polypeptide contains neighboring histidines. The presence of neighboring histidines in the polypeptide enables the polypeptide to be purified over a nickel column (Smith et al., U.S. Pat. No. 4,569,794). In a further preferred embodiment, the recombinant polypeptide contains six neighboring histidines. Ideally, the neighboring histidine group comprises His-His-His-His-His-His. The neighboring histidine group may be placed anywhere in the sequence of the polypeptide. In one preferred embodiment, the neighboring histidine group is placed at amino-terminus of the recombinant polypeptide. In another preferred embodiment, the neighboring histidine group is placed at carboxyl-terminus of the recombinant polypeptide. In a further preferred embodiment, the neighboring histidine is placed between the amino-terminus and carboxyl-terminus of the recombinant polypeptide.

In a further embodiment, the invention relates to a protein standard that has been derivatized by addition of dye molecules, whether visible or fluorescent, isotopic labels or other reporter groups such as biotin, digoxigefin, sugars, or antigens. These derivatives are useful in applications where it is desirable to detect the protein standard by means other than traditional protein stains such as Coomassie blue as long as the mass of the polypeptide is related to the detection intensity of the assay.

The invention is described in further detail in the following non-limiting examples.

### EXAMPLE 1

### A Protein Standard Obtained From Chicken Egg White

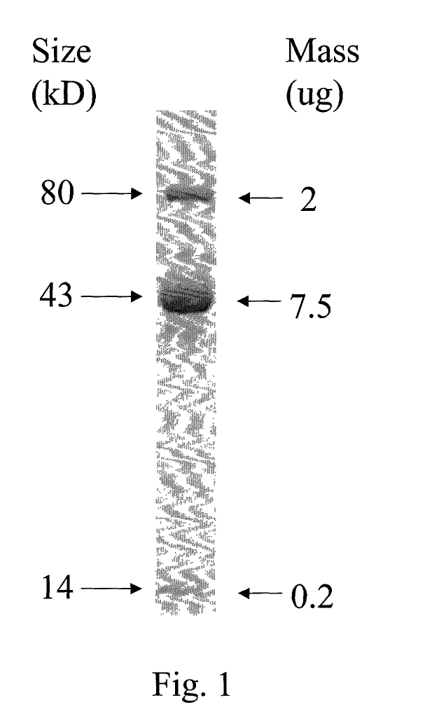

Prepare chicken egg white from a fresh commercial chicken egg. Dissolve the chicken egg white proteins in water by vortex. Estimate the total protein mass by BioRad protein assay (BioRad, Hercules, Calif.) and by Coomassie Blue staining of a SDS gel containing chicken egg white proteins with bovine serum albumin (BSA) as a standard. Prepare the dissolved chicken egg white proteins at concentration of 1 milligram per milliliter in 50 mM Tris HCL pH 8.0, 1 mM EDTA, 1% SDS, 1 mM DTT. A protein standard from chicken egg white is made. Load 10 microliter of the protein standard on 12% SDS polyacrylamide gel. Electrophorese the gel at a constant current of 40 nA per gel. Stain the gel for 10 minutes with Coomassie blue staining solution (0.25% Coomassie brilliant blue R-250, 10% acidic acid, 45% methanol). Destain the gel with 7.5% methanol and 5% acidic acid overnight (above 16 hours). Three major protein bands will be visible on the gel under this condition. They are conalbumin, ovalbumin, and lysozyme. Their sizes are about 80, 43, and 14 kD respectively. Their masses are about 2, 7.5, and 0.2 micrograms (ug) respectively. See FIG. 1.

### EXAMPLE 2

### A Protein Standard With Recombinant Polypeptides

Recombinant proteins bacterial phage T7 RNA polymerase (RP, Dunn et al., J. Mol. Biol. 166:477-535 (1983)), glutathione S-transferase (Smith et al., Proc. Natl. Acad. Sci. USA 83:8703-8707 (1986)) and retinoid X receptor alpha (Mangelsdorf et al., Genes Dev. 6:329-344 (1992)) ligand binding domain fusion protein (GA), retinoid X receptor beta (Marks et al., EMBO j. 11: 1419-1435 (1992)) ligand binding domain and thioredoxin (Wallace et al., Gene 32: 399-408 (1984)) fusion protein (BT), retinoid X receptor beta receptor ligand binding domain (XL), and thioredoxin (TR) were produced and purified as following:

Two oligos RNRPN1 and XNRPC1 (SEQ ID NO: 1 AND 2) were designed and synthesized for RP. Polymerase chain reaction (PCR, Mullis et al, U.S. Pat. No. 4,683,202) was performed at cycling conditions of 94 degree (all the temperatures are indicated in Celsius) for 30 seconds, 65 degree for 30 seconds and 72 degree for 1 minute and 30 seconds. These cycling conditions were repeated for 35 times. Then the reaction was hold at 4 degree. Each oligo is at 2.5 uM. E. coli BL21 (DE3) DNA was used as template. One unit each of Taq and Pfu (Stratagene, La Jolla, Calif.) was used in each reaction of 20 ul. The PCR product was confirmed by electrophoresis on 1% agarose gel. This product was cloned into Nde I digested pET-15b vector (Novagen, Madison, Wis.) by exonuclease III mediated cloning (Li et al., Nucleic Acid Res. 25:4165-4166 (1997)). The annealed PCR product and vector were transformed into competent E. coli strain DH5a (Life Technologies, Inc., Rockville, Md.). The transformed cells were plated on LB ampicillin plate. The plate was incubated at 37 degree over night. Thirteen colonies were picked up for plasmid minipreps. Of these thirteen colonies, four gave the expected two Nde I fragments of expected size. One of these plasmids was chosen and named “pRP”. Recombinant polypeptide RP expressed from pRP was found as inclusion bodies in E. coli BL21 (DE3) cells following induction with isopropy-beta-D-thiogalactopyronoside (IPTG). These inclusion bodies were purified by multiple cycles of sonication and centrifugation. Recombinant polypeptide RP was dissolved in 50 mM Tris HCL pH 8.0, 1 mM EDTA, 1% SDS, and 1 mM DTT at concentration of 10 milligram per milliliter.

Two oligos NGN and BXAC (SEQ ID NOS: 3 AND 4) were designed and synthesized for GA. PCR was performed at cycling conditions of 94 for 30 seconds, 55 degree for one minute, and 72 degree for 1 minute and 30 seconds. These cycling conditions were repeated for 35 times. Then the reaction was hold at 4 degree. Each oligo is at 2.5 uM. Ten nanogram of pGEX-KT-RXR LBD (Li et al., Proc. Natl. Acad. Sci. USA 94, 2278-2283 (1997)) was used as template. One unit of Taq was used in the reaction of 20 ul. The PCR product was confirmed by electrophoresis on 0.8% agarose gel. This PCR product was cloned into Nde I and Bam HI digested pET-15b vector by exonuclease III mediated cloning. Six colonies were picked up for plasmid minipreps. Of these six colonies, three gave the expected Nde I and Bam HI fragments of expected size. One of these plasmids was chosen and named “pGA”. Recombinant polypeptide GA expressed from pGA was found soluble in HKI buffer (20 mM Hepes, pH 8, 100 mM KCL, 20 mM imidazole) in E. coli BL21 (DE3) cells following induction with IPTG. GA was purified by binding to nickel agarose beads and by washing multiple times with HKI buffer. GA was eluted from the beads in HKI buffer containing 250 mM imidazole.

Four oligos HTN, ETTC, BCTN, and BXTC (SEQ ID NOS: 5, 6, 7 AND 8) were designed and synthesized for thioredoxin. Two PCR were performed. The first PCR was performed at cycling conditions of 94 degree for 30 seconds, 68 degree for 1 minute, 72 degree for 1 minute. These cycling conditions were repeated for 40 times. The reaction mixture was pre-heated at 94 degree for 3 minutes. After PCR, the reaction mixture was kept at 72 degree for 5 minutes and hold at 4 degree. Oligos HTN and ETTC were used at concentration of 2 nanogram per microliter each. Half unit of Taq was used in the reaction of 10 ul. E. coli strain W3110 DNA (Sigma catalog number: D-0421) was used as template. The second PCR was performed at cycling conditions of 94 degree for 30 seconds, 60 degree for 30 seconds, and 72 degree for 30 seconds. These cycling conditions were repeated for 30 times. Then the reaction was hold at 4 degree. Oligos BCTN and BXTC were used for second PCR. Each oligo is at 1 uM. The first PCR product was used as template. Ten units of Taq were used in the reaction of 100 microliters. The PCR product was confirmed by electrophoresis on 0.8% agarose gel. This PCR product was cloned into Xho I digested pET-15b-RXR LBD (Li et al., Proc. Natl. Acad. Sci. USA 94, 2278-2283 (1997)) by exonuclease III mediated cloning. Twelve colonies were picked up for plasmid minipreps. Of these twelve colonies, eight gave the expected Xba I and Xho I fragments of expected size. One of these plasmids was chosen and named “pBT”. Recombinant polypeptide BT expressed from pBT was found soluble in HKI buffer (20 mM Hepes, pH 8, 100 mM KCL, 20 mM imidazole) in E. coli BL21 (DE3) cells following induction with IPTG. BT was purified by binding to nickel agarose beads and by washing multiple times with HKI buffer. BT was eluted from the beads in HKI buffer containing 250 mM imidazole.

Recombinant polypeptide XL were expressed and purified from pET-15b-RXR LBD as described (Li et al., Proc. Natl. Acad. Sci. USA 94, 2278-2283 (1997)).

Recombinant polypeptide TR were expressed and purified from pET-32-LIC (Novagen, Madison, Wis.).

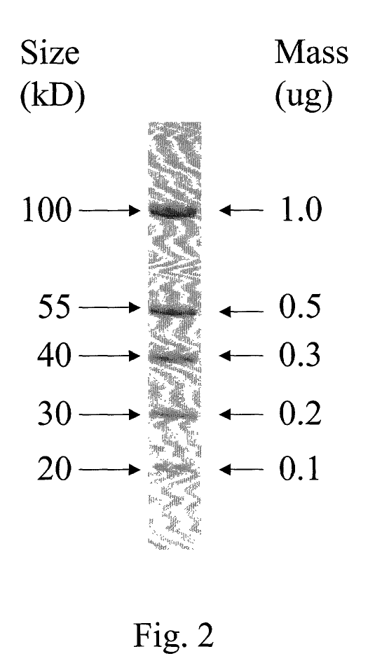

Estimate the concentration of each of these polypeptides by BioRad protein assay and by Coomassie Blue staining of a SDS gel containing these polypeptides and different masses of BSA as a standard. Mix these recombinant polypeptides RP, GA, BT, XL, and TR at concentrations of 100, 50, 30, 20, and 10 microgram per milliliter respectively in 50 mM Tris HCL pH 8.0, 1 mM EDTA, 1% SDS, 1 mM DTT. A protein standard with recombinant polypeptides is made. Load 10 microliter of the protein standard on a precast 4 to 20% gradient gel (Norvex, San Diego, Calif.). Electrophorese the gel at a constant current of 40 mA per gel. Stain the gel for 10 minutes with Coomassie blue staining solution. Destain the gel with 7.5% methanol and 5% acidic acid overnight (above 16 hours). Five major protein bands will be visible on the gel under this condition. They are RP, GA, BT, XL, and TR. Their sizes are about 100, 55, 40, 30, and 20 kD respectively. Their masses are about 1, 0.5, 0.3, 0.2, and 0.1 micrograms (ug) respectively. See FIG. 2.

### EXAMPLE 3

### A Protein Standard With Both Natural and Recombinant Polypeptides

Recombinant polypeptides were prepared as in EXAMPLE 2.

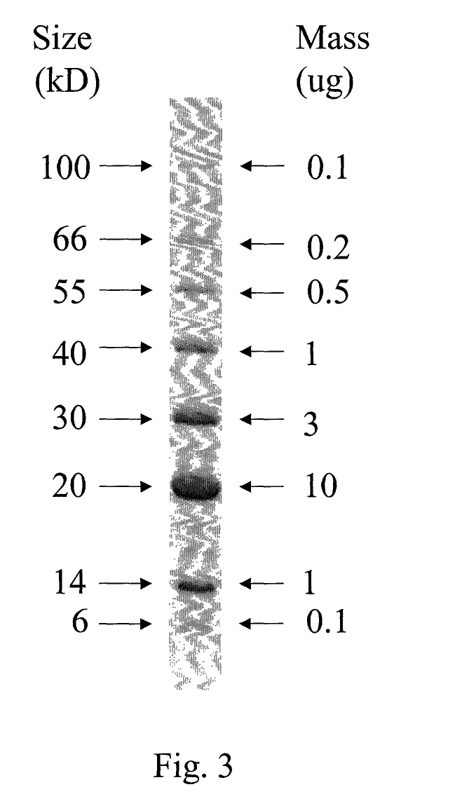

Prepare BSA, lysozyme and aprotinin (Roche Molecular Biochemicals, Indianaplis, Ind.) at concentration of 10 miligram per mililiter. Estimate the concentration of each of these polypeptides by BioRad protein assay and by Coomassie Blue staining of a SDS gel containing these proteins with BSA as a standard. Mix the following polypeptides RP, BSA, GA, BT, XL, TR, lysozyme, and aprotinin at concentration of 10, 20, 50, 100, 300, 1000, 100, and 10 microgram per mililiter respectively in 50 mM Tris HCL pH 8.0, 1 mM EDTA, 1% SDS, 1 mM DTT. A protein standard with commercial natural and recombinant polypetides is made. Load 10 microliter of the protein standard on a precast 4 to 20% gradient gel (Norvex, San Diego, Calif.). Electrophorese the gel at a constant current of 40 mA per gel. Stain the gel for 10 minutes with Coomassie blue staining solution. Destain the gel with 7.5% methanol and 5% acidic acid overnight (above 16 hours). Eight major protein bands will be visible on the gel under this condition. They are RP, BSA, GA, BT, XL, TR, lysozyme, and aprotinin. Their sizes are about 100, 66, 55, 40, 30, 20, 14, and 6 kD respectively. Their masses are about 0.1, 0.2, 0.5, 1, 3, 10, 1, and 0.1 micrograms (ug) respectively. See FIG. 3.

All publications mentioned hereinabove are hereby incorporated their entirety by reference.

While the foregoing invention has been described in some detail for purpose of clarity and understanding, it will be appreciated by one skilled in the art from a reading of this disclosure that various changes in form and detail can be made without departing from the true scope of the invention and appended claims.

What is claimed is:

1. A protein standard comprising a collection of polypeptides wherein;
(a) the protein standard contains at least three polypeptides of different size and of different mass;
(b) the size of all of the polypeptides in kilo Dalton covers a range of at least separable by a given polyacrylamide gel electrophoresis; and
(c) the masses of all of the proteins cover a range of at least detectable by a given detection assay.

2. The protein standard according to claim 1, wherein the polypeptides are from natural sources.

3. The protein standard according to claim 1, wherein the polypeptides are from recombinant sources.

4. The protein standard according to claim 1, wherein the polypeptides are from both natural and recombinant sources.

5. The protein standard according to claim 1, wherein the detecting intensity of the detection assay is related to the polypeptide mass.

6. A protein standard kit comprising a carrier means having in close confinement therein at least one container means where the first container means contains the protein standard according to claim 1.

7. A method of using a protein standard to estimate the size and the mass of the polypeptide in a protein sample comprising:
(a) electrophoresing simultaneously in separate lanes on a gel the protein standard of claim 1 and the protein sample;
(b) detecting the polypeptides on the gel with a detection assay;
(c) comparing the relative positions of polypeptides of said protein standard with the relative position of polypeptide in the protein sample to estimate its size; and
(d) comparing the relative detecting intensities of polypeptides of said protein standard with the relative detecting intensity of polypeptide in the protein sample to estimate its mass.

8. The method according to claim 7, wherein the detecting intensity of the detection assay is related to the polypeptide mass.

9. The method according to claim 7, wherein the protein sample contains one or more polypeptides.

10. A method of preparing a protein standard comprising:
(a) obtaining a few polypeptides with known sizes;
(b) estimating the mass of each of the polypeptides; and
(c) combining the polypeptides with different sizes and masses.

11. The method according to claim 10, wherein the protein standard is produced such that the standard contains at least three polypeptides.

12. The method according to claim 10, wherein the polypeptides are from natural sources.

13. The method according to claim 10, wherein the polypeptides are from recombinant sources.

14. The method according to claim 10, wherein the polypeptides are from both natural and recombinant sources.

15. The method according to claim 10, wherein the range of their sizes is separable by a given polyacrylamide gel electrophoresis.

16. The method according to claim 10, wherein the range of their masses is detectable by a given detection assay.

17. The method according to claim 10, wherein the mass of each of the polypeptides is estimated by a protein assay.

18. The protein assay according to claim 17, wherein the detection intensity of the protein assay is related to the polypeptide mass.

19. The method according to claim 10, wherein the mass of each of the polypeptides is estimated by polyacrylamide gel electrophoresis followed by a detection assay.

20. The method according to claim 19, wherein the detection intensity of the detection assay is related to the polypeptide mass.


SEQUENCE LISTING (8 sequences)

SEQ ID NO: 1 - DNA, 39 bp, Artificial sequence
  Primer
ccgcgcggcagccatatgaacacgattaacatcgctaag

SEQ ID NO: 2 - DNA, 42 bp, Artificial sequence
  Primer
cggatcctcgagcatatgttacgcgaacgcgaagtccgactc

SEQ ID NO: 3 - DNA, 42 bp, Artificial sequence
  Primer
ccgcgcggcagccatatgatactaggttattggaaaattaag

SEQ ID NO: 4 - DNA, 39 bp, Artificial sequence
  Primer
ttgttagcagccggatccttaagtcatttggtgcggcgc

SEQ ID NO: 5 - DNA, 36 bp, Artificial sequence
  Primer
ccatcacggcggttctatgagcgataaaattattca

SEQ ID NO: 6 - DNA, 36 bp, Artificial sequence
  Primer
tcttgtcatcgtcatccgccaggttagcgtcgagga

SEQ ID NO: 7 - DNA, 35 bp, Artificial sequence
  Primer
ccccatcaactggccatgagcgataaaattattca

SEQ ID NO: 8 - DNA, 36 bp, Artificial sequence
  Primer
cagccggatcctcgagttacgccaggttagcgtcga